(19) United States
(12) Patent Application Publication
(10) Pub. No.: US 2010/0060574 A1
(43) Pub. Date: Mar. 11, 2010

(54) OPERATING APPARATUS FOR HAND-HELD ELECTRONIC APPARATUS AND METHOD THEREOF

(76) Inventors: Hsiao-Kuang Lin, Taipei (TW); Kuo-Ping Lee, Taipei (TW)

Correspondence Address: NORTH AMERICA INTELLECTUAL PROPERTY CORPORATION, P.O. BOX 506, MERRIFIELD, VA, 22116, US

(21) Appl. No.: 12/272,802

(22) Filed: Nov. 18, 2008

(30) Foreign Application Priority Data
Sep. 11, 2008 (TW) 097134823

(51) Int. Cl. G09G 5/08

(52) U.S. Cl. 345/158; 455/550.1

(57) ABSTRACT

An operating apparatus for a hand-held electronic apparatus includes a motion sensor, an analog to digital converting module and a processing unit. The motion sensor is utilized for sensing a motion track of the hand-held electronic apparatus to generate an analog sensing signal. The analog to digital converting module is coupled to the motion sensor, and is utilized for converting the analog sensing signal into a digital sensing signal. The processing unit is coupled to the analog to digital converting module, and is utilized for executing a multimedia motion control software to determine whether the motion track of the hand-held electronic apparatus corresponds to a predetermined track according to the digital sensing signal. Furthermore, the processing unit executes at least one predetermined function corresponding to the predetermined track from a plurality of predetermined functions when determining that the motion track corresponds to the predetermined track.

### BACKGROUND OF THE INVENTION

1. Field of the Invention

The present invention relates to an apparatus for operating a hand-held electronic device, and more particularly, to an apparatus capable of operating a hand-held electronic device without needing to activate the screen of the hand-held electronic device.

2. Description of the Prior Art

Current electronic hand-held devices integrate a plurality of features in order to meet consumer needs. Among those features, multi-media functions, such as video, audio, picture-browsing etc. are utilized the most by a user. In conventional methods, these functions are controlled through the keypad or touch-screen disposed on the outer surface of the electronic hand-held device. However, the screen of an electronic hand-held device is automatically turned off while the electronic hand-held device is in a special mode, such as power-saving mode or sleeping mode. When the user desires to control or operate the electronic hand-held device while the screen of the electronic hand-held device is off, the user has to switch the electronic hand-held device to the normal mode from the special mode; in other words, the screen of the electronic hand-held device needs to be switched on in order for a user to control or operate the electronic hand-held device. This is inconvenient. Thus, there is a need to improve the current operating function to increase convenience of operation.

### SUMMARY OF THE INVENTION

It is therefore one of the objectives of the present invention to provide an apparatus for operating a hand-held electronic device which controls the hand-held electronic device by sensing a motion track via a motion sensor to execute a corresponding operation.

According to an exemplary embodiment of the present invention, an apparatus for operating a hand-held electronic device is disclosed. The apparatus comprises: a motion sensor, which is for sensing a motion track of the hand-held electronic device to generate an analog sensing signal; an analog to digital converting module, which is coupled to the motion sensor, and is for converting the analog sensing signal into a digital sensing signal; and a processing unit, which is coupled to the analog to digital converting module, and is for executing a multimedia motion control (MMC) software to determine whether the motion track of the hand-held electronic device corresponds to a predetermined track according to the digital sensing signal, and for executing at least one predetermined function corresponding to the predetermined track from a plurality of predetermined functions when determining that the motion track corresponds to the predetermined track.

According to an exemplary embodiment of the present invention, a method for operating a hand-held electronic device is also disclosed. The method comprises: sensing a motion track of the hand-held electronic device to generate an analog sensing signal; converting the analog sensing signal into a digital sensing signal; and executing a multimedia motion control (MMC) software to determine whether the motion track of the hand-held electronic device corresponds to a predetermined track according to the digital sensing signal, and executing at least one predetermined function corresponding to the predetermined track from a plurality of predetermined functions when determining the motion track corresponds to the predetermined track.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a hand-held electronic device having an operating apparatus according to a first embodiment of the present invention.

FIG. 2 is a diagram illustrating relations between the predetermined functions and the predetermined tracks for the hand-held electronic device shown in FIG. 1 corresponding to different modes.

FIG. 3 is a diagram illustrating other corresponding relations between the predetermined functions and other predetermined tracks for the hand-held electronic device shown in FIG. 1 in different modes.

FIG. 4 is a block diagram illustrating a hand-held electronic device having an operating apparatus according to a second embodiment of the present invention.

FIG. 5 is a diagram illustrating relations between the predetermined functions and the predetermined tracks for the hand-held electronic device shown in FIG. 4 corresponding to different modes.

FIG. 6 is a flowchart illustrating a method for operating a hand-held electronic device according to a first embodiment of the present invention.

FIG. 7 is a flowchart illustrating a method for operating a hand-held electronic device according to a second embodiment of the present invention.

### DETAILED DESCRIPTION

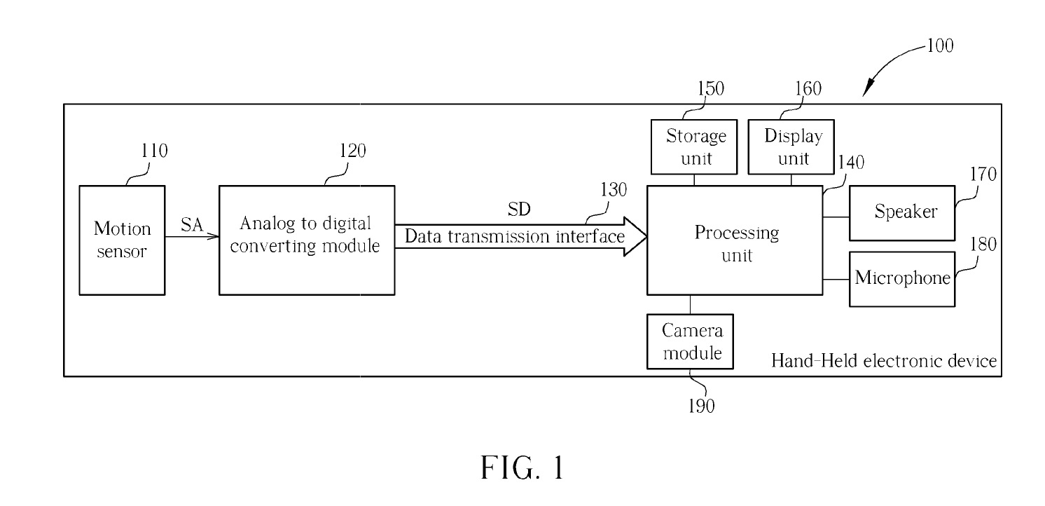

Please refer to FIG. 1. FIG. 1 is a block diagram illustrating a hand-held electronic device 100 having an operating apparatus according to a first embodiment of the present invention. As shown in FIG. 1, the hand-held electronic device 100 comprises a motion sensor 110, an analog to digital converting module 120, a data transmission interface 130, a processing unit 140, a storage unit 150, a display unit 160, a speaker 170, a microphone 180 and a camera module 190. The motion sensor 110, such as a capacitive motion sensor, is configured for sensing a motion track of the hand-held electronic device 100 to generate an analog sensing signal SA. The motion track of the hand-held electronic device 100 is generated from moving or shaking of the hand-held electronic device 100 by the user. The analog to digital converting module 120 is coupled to the motion sensor 110, and is configured to convert the analog sensing signal SA into a digital sensing signal SD. The data transmission interface 130, such as an Inter-IC or a serial peripheral interface (SPI) is coupled between the analog to digital converting module 120 and the processing unit 140, and is configured for transmitting the digital sensing signal SD from the analog to digital converting module 120 to the processing unit 140. The processing unit 140, such as a processor, is coupled to the storage unit 150, the display unit 160, the speaker 170, the microphone 180 and the camera module 190, and is configured for controlling the storage unit 150, the display unit 160, the speaker 170, the microphone 180 and the camera module 190 to respectively execute one of a plurality of predetermined functions according to the digital sensing signal SD. The processing unit 140 executes a multimedia motion control (MMC) software to determine whether the motion track of the hand-held electronic device 100 corresponds to a predetermined track according to the digital sensing signal SD after receiving the digital sensing signal SD. The MMC is written into the processing unit 140. When the processing unit 140 determines that the motion track of the hand-held electronic device 100 corresponds to the predetermined track according to the digital sensing signal SD, the processing unit 140 executes a predetermined function corresponding to the predetermined track. When the processing unit 140 determines that the motion track of the hand-held electronic device 100 does not correspond to any predetermined track according to the digital sensing signal SD, the processing unit 140 does not execute any of the predetermined functions. Further description of the hand-held electronic device 100 is detailed as follows; however, this is merely for illustrative purposes and is not a limitation of the present invention.

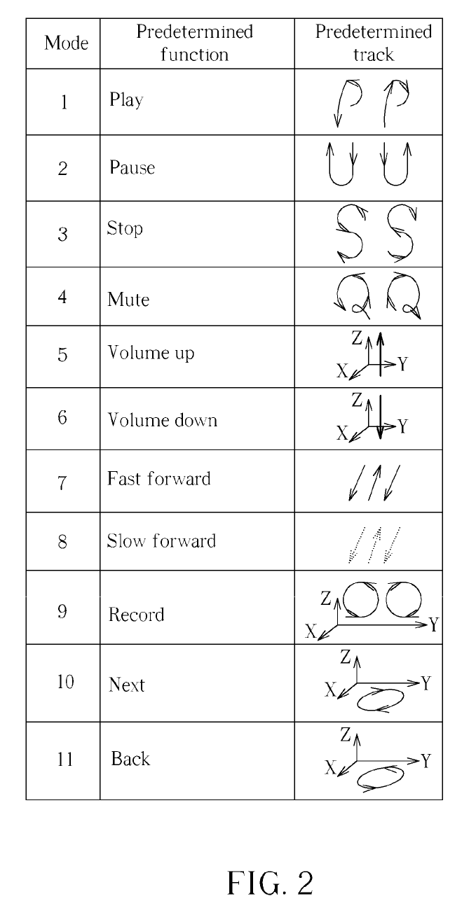

For example, in an embodiment of the present invention, the hand-held electronic device 100 is a mobile phone capable of playing multimedia data and has (but is not limited to) eleven modes corresponding to eleven predetermined functions, respectively. Please refer to FIG. 2. FIG. 2 is a diagram illustrating relations between the predetermined functions and the predetermined tracks for the hand-held electronic device 100 corresponding to different modes. As shown in FIG. 2, mode 1 corresponds to a play function of the predetermined functions; mode 2 corresponds to a pause function of the predetermined functions; mode 3 corresponds to a stop function of the predetermined functions; mode 4 corresponds to a mute function of the predetermined functions; mode 5 corresponds to a volume up function of the predetermined functions; mode 6 corresponds to a volume down function of the predetermined functions; mode 7 corresponds to a fast forward function of the predetermined functions; mode 8 corresponds to a slow forward function of the predetermined functions; mode 9 corresponds to a record function of the predetermined functions; mode 10 corresponds to a next function of the predetermined functions; and mode 11 corresponds to a back function of the predetermined functions.

Please continue to refer to FIG. 2. In mode 1, when the processing unit 140 determines that the motion track of the hand-held electronic device 100 corresponds to a P track according to the digital sensing signal SD, the processing unit 140 executes the play function of the predetermined functions. For example, the processing unit 140 controls the display unit 160 and the speaker 170 to play a file stored in the storage unit 150. In mode 2, when the processing unit 140 determines that the motion track of the hand-held electronic device 100 corresponds to a U track according to the digital sensing signal SD, the processing unit 140 executes the pause function of the predetermined functions. For example, the processing unit 140 controls the display unit 160 and the speaker 170 to stop playing the file for a period of time. In mode 3, when the processing unit 140 determines that the motion track of the hand-held electronic device 100 corresponds to an S track according to the digital sensing signal SD, the processing unit 140 executes the stop function of the predetermined functions. For example, the processing unit 140 controls the display unit 160 and the speaker 170 to stop playing the file. In mode 4, when the processing unit 140 determines that the motion track of the hand-held electronic device 100 corresponds to a Q track according to the digital sensing signal SD, the processing unit 140 executes the mute function of the predetermined functions. For example, the processing unit 140 controls the speaker 170 not to operate. In mode 5, when the processing unit 140 determines that the motion track of the hand-held electronic device 100 corresponds to a straight line track towards a first direction (e.g., a +Z direction) according to the digital sensing signal SD, the processing unit 140 executes the volume up function of the predetermined functions. For example, the processing unit 140 controls the speaker 170 to increase the volume when playing the file. In mode 6, when the processing unit 140 determines that the motion track of the hand-held electronic device 100 corresponds to a straight line track towards a second direction opposite to the first direction (e.g., a −Z direction) according to the digital sensing signal SD, the processing unit 140 executes the volume down function of the predetermined functions. For example, the processing unit 140 controls the speaker 170 to decrease the volume when playing the file. In mode 7, when the processing unit 140 determines that the motion track of the hand-held electronic device 100 corresponds to a straight line reciprocating track whose reciprocation frequency is higher than a predetermined reciprocation frequency according to the digital sensing signal SD, the processing unit 140 executes the fast forward function of the predetermined functions. For example, the processing unit 140 controls the display unit 160 and the speaker 170 to play the file fast. In mode 8, when the processing unit 140 determines that the motion track of the hand-held electronic device 100 corresponds to a straight line reciprocating track whose reciprocation frequency is lower than the predetermined reciprocation frequency according to the digital sensing signal SD, the processing unit 140 executes the slow forward function of the predetermined functions. For example, the processing unit 140 controls the display unit 160 and the speaker 170 to play the file slowly. In mode 9, when the processing unit 140 determines that the motion track of the hand-held electronic device 100 corresponds to an 0 track on a first plane (e.g., a Z-Y plane) according to the digital sensing signal SD, the processing unit 140 executes the record function of the predetermined functions. For example, the processing unit 140 controls the microphone 180 and the camera module 190 to record video data into the storage unit 150, or only controls the microphone 180 to record audio data into the storage unit 150. In mode 10, when the processing unit 140 determines that the motion track of the hand-held electronic device 100 corresponds to an O track on a second plane perpendicular to the first plane (e.g., a X-Y plane) in a first clock direction (e.g., clockwise) according to the digital sensing signal SD, the processing unit 140 executes the next function of the predetermined functions. For example, the processing unit 140 controls the display unit 160 and the speaker 170 to play a next file stored in the storage unit 150. In mode 11, when the processing unit 140 determines that the motion track of the hand-held electronic device 100 corresponds to an O track on the second plane (e.g., a X-Y plane) in a second clock direction opposite to the first clock direction (e.g., counterclockwise) according to the digital sensing signal SD, the processing unit 140 executes the back function of the predetermined functions. For example, the processing unit 140 controls the display unit 160 and the speaker 170 to play a last file stored in the storage unit 150. When the processing unit 140 determines that the motion track of the hand-held electronic device 100 does not correspond to any predetermined track according to the digital sensing signal SD, the processing unit 140 does not execute any of the predetermined functions. Because the method of the processing unit 140 executing the play function, the pause function, the stop function, the mute function, the volume up function, the volume down function, the fast forward function, the slow forward function, the record function, the next function and the back function is well known to those skilled in the art, further description is omitted here for brevity.

As can be seen from the above, the user can generate different motion tracks by moving or shaking the hand-held electronic device 100 in order to control the hand-held electronic device 100 to execute different predetermined functions.

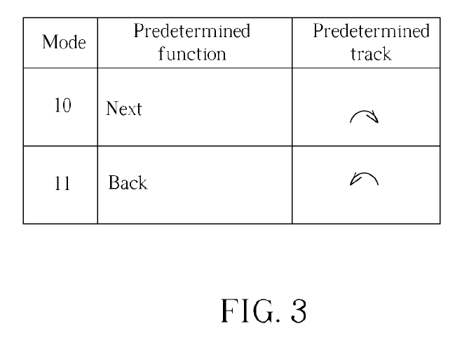

Please note that the corresponding relation between the predetermined functions and the predetermined tracks in different modes shown in FIG. 2 is merely for illustrative purposes and is not a limitation of the present invention. In practice, the predetermined functions in different modes may correspond to other predetermined tracks depending on design requirement. Please refer to FIG. 3. For example, FIG. 3 is a diagram illustrating other corresponding relations between the predetermined functions and other predetermined tracks for the hand-held electronic device 100 in different modes. As shown in FIG. 3, when the processing unit 140 determines that the motion track of the hand-held electronic device 100 corresponds to an arc track in a first clock direction (e.g., clockwise) according to the digital sensing signal SD, the processing unit 140 executes the next function of the predetermined functions; when the processing unit 140 determines that the motion track of the hand-held electronic device 100 corresponds to an arc track in a second clock direction (e.g., counterclockwise) according to the digital sensing signal SD, the processing unit 140 executes the back function of the predetermined functions. This alternative design also falls within the scope of the present invention.

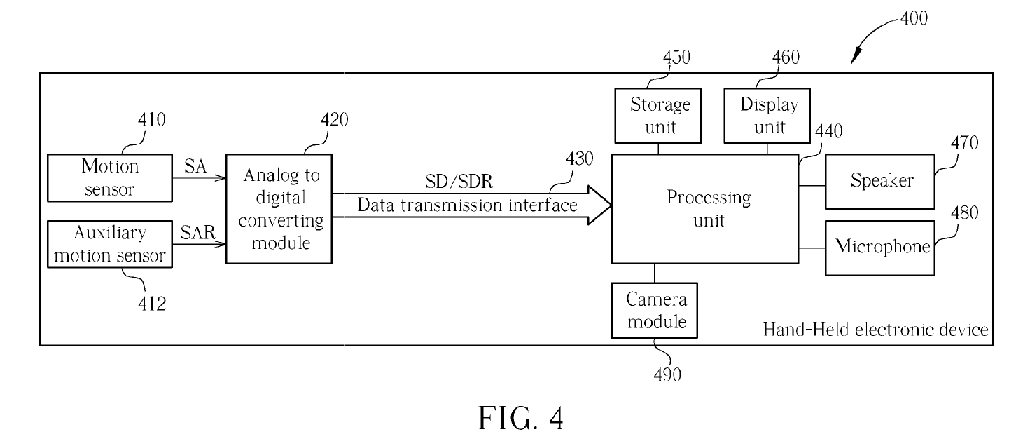

Please refer to FIG. 4. FIG. 4 is a block diagram illustrating a hand-held electronic device having an operating apparatus according to a second embodiment of the present invention. As shown in FIG. 4, the hand-held electronic device 100 comprises a motion sensor 410, an analog to digital converting module 420, a data transmission interface 430, a processing unit 440, a storage unit 450, a display unit 460, a speaker 470, a microphone 480 and a camera module 490. The hand-held electronic device 100 further comprises an auxiliary motion sensor 412. Please note that the motion sensor 410 and the analog to digital converting module 420 are the same two motion sensors in the present invention. For example, the motion sensor 410 and the analog to digital converting module 420 are both capacitive motion sensors in this embodiment.

In the hand-held electronic device 400, the auxiliary motion sensor 412 is configured for providing an analog reference signal SAR according to a held state of the hand-held electronic device 400. The analog sensing signal SAR is converted into a digital reference signal SDR by the analog to digital converting module 420, then the digital sensing signal SDR is transmitted to the processing unit 440 via the data transmission interface 430. The processing unit 440 determines whether the held state of the hand-held electronic device 400 is in a first state or in a second state according to the digital reference signal, such as a normal state or an upside down state. When the processing unit 440 determines the held state of the hand-held electronic device 400 is in the first state and the motion track of the hand-held electronic device 400 corresponds to a predetermined track, the processing unit 440 executes a first predetermined function; when the processing unit 440 determines the held state of the hand-held electronic device 400 is in the second state and the motion track of the hand-held electronic device 400 corresponds to the predetermined track, the processing unit 440 executes a second predetermined function different from the first predetermined function. In other words, with the help of the auxiliary motion sensor 412, the processing unit 440 is able to execute different predetermined functions by referring to different held states of the hand-held electronic device 400 even though the different predetermined functions correspond to the same predetermined track.

Because the operations of the motion sensor 410, the analog to digital converting module 420, the data transmission interface 430, and the processing unit 440 in the hand-held electronic device 400 are similar to that of, respectively, the motion sensor 110, the analog to digital converting module 120, the data transmission interface 130, and the processing unit 140 in the hand-held electronic device 100, further description is not detailed here for brevity. Further description of the operation of the hand-held electronic device 400 is detailed as follows; however, this is merely for illustrative purposes and is not a limitation of the present invention.

For example, in an embodiment of the present invention, the hand-held electronic device 400 is a mobile phone capable of playing multimedia data and has (but is not limited to) thirteen modes corresponding to thirteen predetermined functions, respectively. Mode 1 corresponds to a play function of the predetermined functions; mode 2 corresponds to a pause function of the predetermined functions; mode 3 corresponds to a stop function of the predetermined functions; mode 4 corresponds to a mute function of the predetermined functions; mode 5 corresponds to a volume up function of the predetermined functions; mode 6 corresponds to a volume down function of the predetermined functions; mode 7 corresponds to a fast forward function of the predetermined functions; mode 8 corresponds to a slow forward function of the predetermined functions; mode 9 corresponds to a record function of the predetermined functions; mode 10 corresponds to a next function of the predetermined functions; mode 11 corresponds to a back function of the predetermined functions; mode 12 corresponds to a fast reverse function of the predetermined functions; and mode 13 corresponds to a slow reverse function of the predetermined functions.

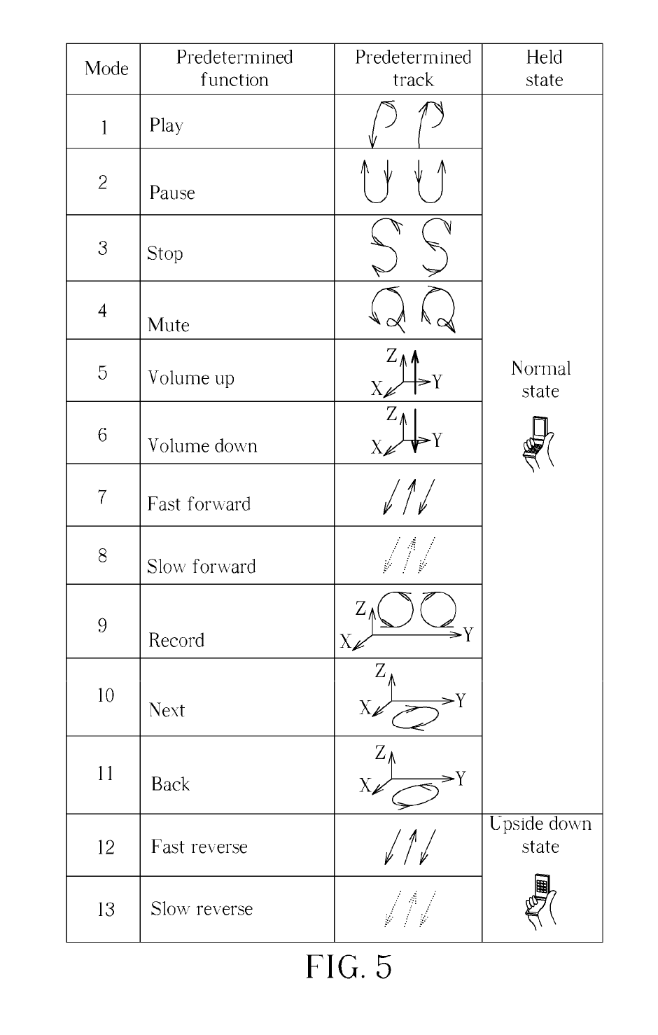

Please refer to FIG. 5. FIG. 5 is a diagram illustrating relations between the predetermined functions and the predetermined tracks for the hand-held electronic device 400 corresponding to different modes. In mode 7, when the processing unit 440 determines that the motion track of the hand-held electronic device 400 corresponds to a straight line reciprocating track whose reciprocation frequency is higher than a predetermined reciprocation frequency according to the digital sensing signal SD, and the held state of the hand-held electronic device 440 is in the normal state according to the digital sensing signal SDR, the processing unit 440 executes the fast forward function of the predetermined functions. For example, the processing unit 440 controls the display unit 460 and the speaker 470 to play the file fast. In mode 12, when the processing unit 440 determines that the motion track of the hand-held electronic device 400 corresponds to a straight line reciprocating track whose reciprocation frequency is higher than the predetermined reciprocation frequency according to the digital sensing signal SD, and the held state of the hand-held electronic device 440 is in the upside down state according to the digital sensing signal SDR, the processing unit 440 executes the fast reverse function of the predetermined functions. For example, the processing unit 440 controls the display unit 460 and the speaker 470 to reverse play the file fast. In mode 8, when the processing unit 440 determines that the motion track of the hand-held electronic device 400 corresponds to a straight line reciprocating track whose reciprocation frequency is lower than the predetermined reciprocation frequency according to the digital sensing signal SD, and the held state of the hand-held electronic device 440 is in the normal state according to the digital sensing signal SDR, the processing unit 440 executes the slow forward function of the predetermined functions. For example, the processing unit 440 controls the display unit 460 and the speaker 470 to play the file slowly. In mode 13, when the processing unit 440 determines that the motion track of the hand-held electronic device 400 corresponds to a straight line reciprocating track whose reciprocation frequency is lower than the predetermined reciprocation frequency according to the digital sensing signal SD, and the held state of the hand-held electronic device 440 is in the upside down state according to the digital sensing signal SDR, the processing unit 440 executes the slow reverse function of the predetermined functions. For example, the processing unit 440 controls the display unit 460 and the speaker 470 to reverse play the file slowly.

Because the corresponding relation between the predetermined functions and the predetermined tracks for the hand-held electronic device 400 are the same as that for the hand-held electronic device 100 in other modes, further description is omitted here for brevity. Because the method of the processing unit 440 executing the play function, the pause function, the stop function, the mute function, the fast forward function, the slow forward function, the fast reverse function, the volume up function, the volume down function, the fast forward function, the slow forward function, the record function, the next function, the back function, the fast reverse function and the slow reverse function is well known to those skilled in the art, further description is also omitted here for brevity.

Please note that, in the above embodiments, the hand-held electronic device 100 and the hand-held electronic device 400 are both mobile phones capable of playing multimedia data (e.g., an MP3 file); however, this is merely for illustrative purposes and is not a limitation of the present invention. In other embodiments of the present invention, the operating apparatus is able to used to control any hand-held electronic device capable of playing multimedia data (e.g., a personal digital assistant, PDA) or multimedia player (e.g., an MP3 player).

Please note that, in the above embodiments, the processing unit 140 and the processing unit 440 both determine whether the motion track of the hand-held electronic device corresponds to a predetermined track by executing an MMC software; however, this is merely for illustrative purposes and is not a limitation of the present invention.

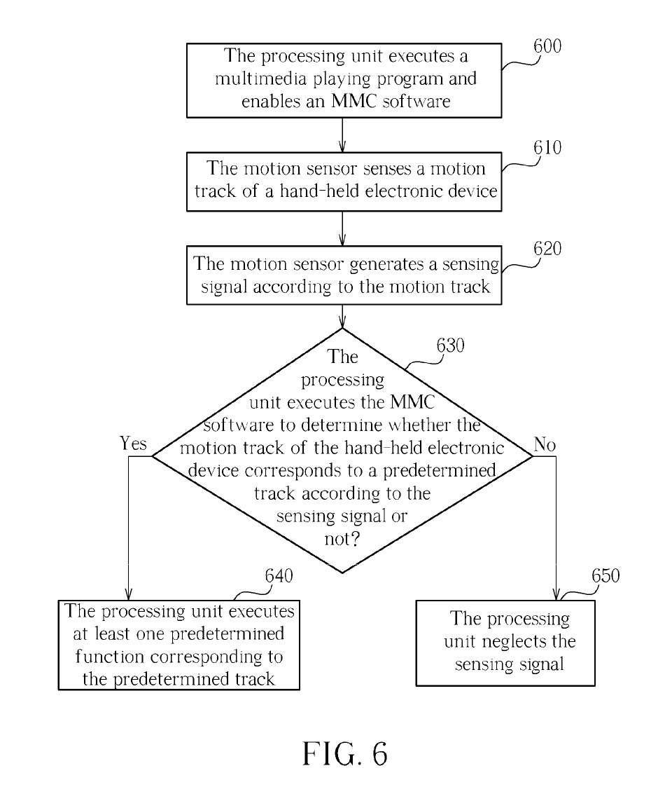

Please refer to FIG. 6. FIG. 6 is a flowchart illustrating a method for operating a hand-held electronic device according to a first embodiment of the present invention. Provided that substantially the same result is achieved, the steps of the flowchart shown in FIG. 6 need not be in the exact order shown and need not be contiguous, that is, other steps can be intermediate. The operating method includes the following steps:

Step 600: the processing unit executes a multimedia playing program and enables an MMC software;

Step 610: the motion sensor senses a motion track of a hand-held electronic device;

Step 620: the motion sensor generates a sensing signal according to the motion track;

Step 630: the processing unit executes the MMC software to determine whether the motion track of the hand-held electronic device corresponds to a predetermined track according to the sensing signal or not. If yes, the method proceeds to Step 640; otherwise, the method proceeds to Step 650;

Step 640: the processing unit executes at least one predetermined function corresponding to the predetermined track;

Step 650: the processing unit neglects the sensing signal.

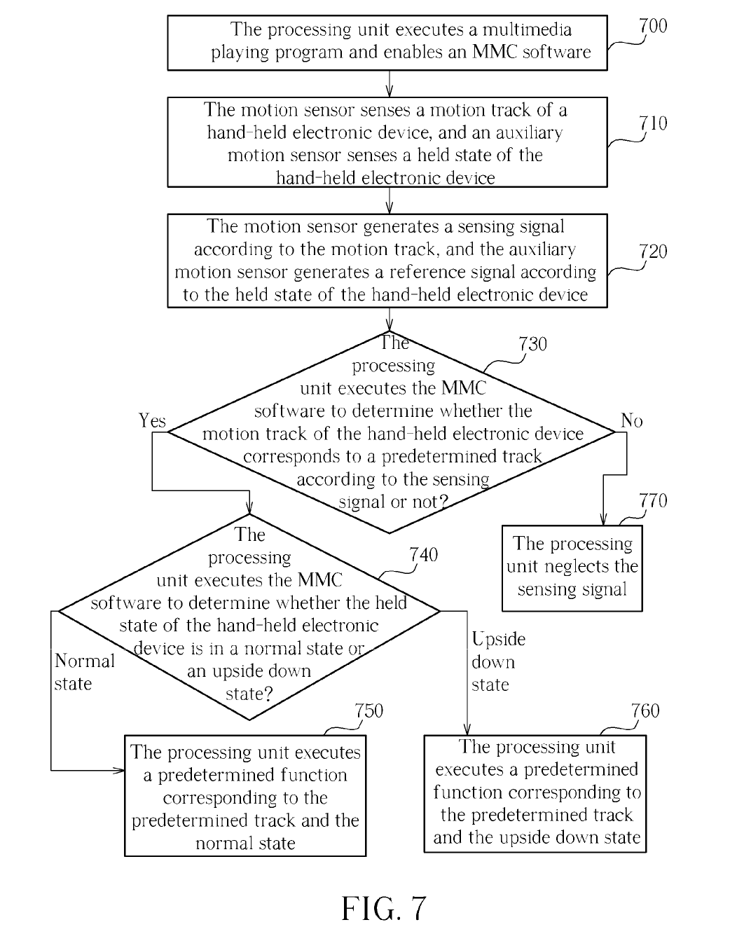

Please refer to FIG. 7. FIG. 7 is a flowchart illustrating a method for operating a hand-held electronic device according to a second embodiment of the present invention. Provided that substantially the same result is achieved, the steps of the flowchart shown in FIG. 7 need not be in the exact order shown and need not be contiguous, that is, other steps can be intermediate. The operating method includes the following steps:

Step 700: the processing unit executes a multimedia playing program and enables an MMC software;

Step 710: the motion sensor senses a motion track of a hand-held electronic device, and an auxiliary motion sensor senses a held state of the hand-held electronic device;

Step 720: the motion sensor generates a sensing signal according to the motion track, and the auxiliary motion sensor generates a reference signal according to the held state of the hand-held electronic device;

Step 730: the processing unit executes the MMC software to determine whether the motion track of the hand-held electronic device corresponds to a predetermined track according to the sensing signal or not. If yes, the method proceeds to Step 740; otherwise, the method proceeds to Step 770;

Step 740: the processing unit executes the MMC software to determine whether the held state of the hand-held electronic device is in a normal state or an upside down state. If in the normal state, the method proceeds to Step 750; if in the upside down state, the method proceeds to Step 760;

Step 750: the processing unit executes a predetermined function corresponding to the predetermined track and the normal state;

Step 760: the processing unit executes a predetermined function corresponding to the predetermined track and the upside down state;

Step 770: the processing unit neglects the sensing signal.

After reading the above-mentioned description concerning the operation of the hand-held electronic device 100 and the hand-held electronic device 400, those skilled in the art should readily understand the operation concerning the steps of the flowcharts shown in FIG. 6 and FIG. 7. Thus, further description of the flowcharts in FIG. 6 and FIG. 7 is omitted here for brevity.

Compared with the prior art, the user is still able to control the a hand-held electronic device having an operating apparatus of the present invention by shaking or moving the hand-held electronic device even when the screen is not activated.

Those skilled in the art will readily observe that numerous modifications and alterations of the device and method may be made while retaining the teachings of the invention.

What is claimed is:

1. An apparatus for operating a hand-held electronic device, comprising:
a motion sensor, for sensing a motion track of the hand-held electronic device to generate an analog sensing signal;
an analog to digital converting module, coupled to the motion sensor, for converting the analog sensing signal into a digital sensing signal; and
a processing unit, coupled to the analog to digital converting module, for executing a multimedia motion control (MMC) software to determine whether the motion track of the hand-held electronic device corresponds to a predetermined track according to the digital sensing signal, and executing at least one predetermined function corresponding to the predetermined track from a plurality of predetermined functions when determining that the motion track corresponds to the predetermined track.

2. The apparatus for operating the hand-held electronic device of claim 1, wherein the plurality of predetermined functions comprise at least one of a play function, a pause function, a stop function, a mute function, a fast forward function, a slow forward function, a fast reverse function, a slow reverse function, a volume up function, a volume down function, a next function, a back function and a record function.

3. The apparatus for operating the hand-held electronic device of claim 2, wherein the processing unit executes the play function when determining that the motion track of the hand-held electronic device corresponds to a P track according to the digital sensing signal.

4. The apparatus for operating the hand-held electronic device of claim 2, wherein the processing unit executes the pause function when determining that the motion track of the hand-held electronic device corresponds to a U track according to the digital sensing signal.

5. The apparatus for operating the hand-held electronic device of claim 2, wherein the processing unit executes the stop function when determining that the motion track of the hand-held electronic device corresponds to an S track according to the digital sensing signal.

6. The apparatus for operating the hand-held electronic device of claim 2, wherein the processing unit executes the mute function when determining that the motion track of the hand-held electronic device corresponds to a Q track according to the digital sensing signal.

7. The apparatus for operating the hand-held electronic device of claim 2, wherein the processing unit executes the volume up function when determining that the motion track of the hand-held electronic device corresponds to a straight line track towards a first direction according to the digital sensing signal; and the processing unit executes the volume down function when determining that the motion track of the hand-held electronic device corresponds to a straight line track towards a second direction opposite to the first direction according to the digital sensing signal.

8. The apparatus for operating the hand-held electronic device of claim 2, wherein the processing unit executes the fast forward function when determining that the motion track of the hand-held electronic device corresponds to a straight line reciprocating track whose reciprocation frequency is higher than a predetermined reciprocation frequency according to the digital sensing signal; and the processing unit executes the slow forward function when determining that the motion track of the hand-held electronic device corresponds to a straight line reciprocating track whose reciprocation frequency is lower than the predetermined reciprocation frequency according to the digital sensing signal.

9. The apparatus for operating the hand-held electronic device of claim 1, further comprising:
an auxiliary motion sensor, for providing an analog reference signal according to a held state of the hand-held electronic device;
wherein the analog to digital converting module converts the analog reference signal into a digital reference signal and outputs the digital reference signal to the processing unit, the processing unit determines whether the held state of the hand-held electronic device is in a first state or in a second state according to the digital reference signal; the processing unit executes a first predetermined function when determining that the held state of the hand-held electronic device is in the first state and the motion track of the hand-held electronic device corresponds to the predetermined track; and the processing unit executes a second predetermined function different from the first predetermined function when determining that the held state of the hand-held electronic device is in the second state and the motion track of the hand-held electronic device corresponds to the predetermined track.

10. The apparatus for operating the hand-held electronic device of claim 9, wherein the predetermined track is a straight line reciprocating track whose reciprocation frequency is higher than a predetermined reciprocation frequency, the first predetermined function is a fast forward function, and the second predetermined function is a fast reverse function.

11. The apparatus for operating the hand-held electronic device of claim 9, wherein the predetermined track is a straight line reciprocating track whose reciprocation frequency is lower than a predetermined reciprocation frequency, the first predetermined function is a slow forward function, and the second predetermined function is a slow reverse function.

12. The apparatus for operating the hand-held electronic device of claim 2, wherein the processing unit executes the next function when determining that the motion track of the hand-held electronic device corresponds to an arc track in a first clock direction according to the digital sensing signal; and the processing unit executes the back function when determining that the motion track of the hand-held electronic device corresponds to an arc track in a second clock direction opposite to the first clock direction according to the digital sensing signal.

13. The apparatus for operating the hand-held electronic device of claim 2, wherein the processing unit executes the record function when determining that the motion track of the hand-held electronic device corresponds to an O track on a first plane according to the digital sensing signal; the processing unit executes the next function when determining that the motion track of the hand-held electronic device corresponds to an O track on a second plane perpendicular to the first plane in a first clock direction according to the digital sensing signal; and the processing unit executes the back function when determining that the motion track of the hand-held electronic device corresponds to an O track on the second plane in a second clock direction opposite to the first clock direction according to the digital sensing signal.

14. The apparatus for operating the hand-held electronic device of claim 1, wherein the motion sensor is a capacitive motion sensor.

15. The apparatus for operating the hand-held electronic device of claim 1, further comprising:
a data transmission interface, coupled between the analog to digital converting module and the processing unit, for transmitting the digital sensing signal form the analog to digital converting module to the processing unit.

16. The apparatus for operating the hand-held electronic device of claim 15, wherein the data transmission interface is an Inter-IC or a serial peripheral interface (SPI).

17. A method for operating a hand-held electronic device, comprising:
sensing a motion track of the hand-held electronic device to generate an analog sensing signal;
converting the analog sensing signal into a digital sensing signal; and
executing a multimedia motion control (MMC) software to determine whether the motion track of the hand-held electronic device corresponds to a predetermined track according to the digital sensing signal, and executing at least one predetermined function corresponding to the predetermined track from a plurality of predetermined functions when determining that the motion track corresponds to the predetermined track.

18. The apparatus for operating the hand-held electronic device of claim 17, wherein the plurality of predetermined functions comprise at least one of a play function, a pause function, a stop function, a mute function, a fast forward function, a slow forward function, a fast reverse function, a slow reverse function, a volume up function, a volume down function, a next function, a back function and a record function.

19. The method for operating the hand-held electronic device of claim 18, executing the play function when determining that the motion track of the hand-held electronic device corresponds to a P track according to the digital sensing signal.

20. The method for operating the hand-held electronic device of claim 18, executing the pause function when determining that the motion track of the hand-held electronic device corresponds to a U track according to the digital sensing signal.

21. The method for operating the hand-held electronic device of claim 18, executing the stop function when determining that the motion track of the hand-held electronic device corresponds to an S track according to the digital sensing signal.

22. The method for operating the hand-held electronic device of claim 18, executing the mute function when determining that the motion track of the hand-held electronic device corresponds to a Q track according to the digital sensing signal.

23. The method for operating the hand-held electronic device of claim 18, executing the volume up function when determining that the motion track of the hand-held electronic device corresponds to a straight line track towards a first direction according to the digital sensing signal; and
executing the volume down function when determining that the motion track of the hand-held electronic device corresponds to a straight line track towards a second direction according to the digital sensing signal.

24. The method for operating the hand-held electronic device of claim 18, executing the fast forward function when determining that the motion track of the hand-held electronic device corresponds to a straight line reciprocating track whose reciprocation frequency is higher than a predetermined reciprocation frequency according to the digital sensing signal; and
executing the slow forward function when determining that the motion track of the hand-held electronic device corresponds to a straight line reciprocating track whose reciprocation frequency is lower than the predetermined reciprocation frequency according to the digital sensing signal.

25. The method for operating the hand-held electronic device of claim 17, further comprising:
providing an analog reference signal according to a held state of the hand-held electronic device;
converting the analog reference signal into a digital reference signal;
determining whether the held state of the hand-held electronic device is in a first state or in a second state according to the digital reference signal;
executing a first predetermined function when determining that the held state of the hand-held electronic device is in the first state and the motion track of the hand-held electronic device corresponds to the predetermined track; and
executing a second predetermined function different from the first predetermined function when determining that the held state of the hand-held electronic device is in the second state and the motion track of the hand-held electronic device corresponds to the predetermined track.

26. The method for operating the hand-held electronic device of claim 25, wherein the predetermined track is a straight line reciprocating track whose reciprocation frequency is higher than a predetermined reciprocation frequency, the first predetermined function is a fast forward function, and the second predetermined function is a fast reverse function.

27. The method for operating the hand-held electronic device of claim 25, wherein the predetermined track is a straight line reciprocating track whose reciprocation frequency is lower than a predetermined reciprocation frequency, the first predetermined function is a slow forward function, and the second predetermined function is a slow reverse function.

28. The method for operating the hand-held electronic device of claim 18, executing the next function when determining that the motion track of the hand-held electronic device corresponds to an arc track in a first clock direction according to the digital sensing signal; and
executing the back function when determining that the motion track of the hand-held electronic device corresponds to an arc track in a second clock direction opposite to the first clock direction according to the digital sensing signal.

29. The method for operating the hand-held electronic device of claim 18, executing the record function when determining that the motion track of the hand-held electronic device corresponds to an O track on a first plane according to the digital sensing signal;
executing the next function when determining that the motion track of the hand-held electronic device corresponds to an O track on a second plane perpendicular to the first plane in a first clock direction according to the digital sensing signal; and
executing the back function when determining that the motion track of the hand-held electronic device corresponds to an O track on the second plane in a second clock direction opposite to the first clock direction according to the digital sensing signal.
